(19) United States
(12) Patent Application Publication
(10) Pub. No.: US 2012/0110207 A1
(43) Pub. Date: May 3, 2012

(54) EMBEDDING ZONE IDENTIFIERS IN IP ADDRESSES

(75) Inventor: Seth D. Jennings, Austin, TX (US)

(73) Assignee: International Business Machines Corporation, Armonk, NY (US)

(21) Appl. No.: 12/917,301

(22) Filed: Nov. 1, 2010

(51) Int. Cl. G06F 15/16

(52) U.S. Cl. 709/245

(57) ABSTRACT

Internet Protocol Version 6 (IPv6) was described in RFC 2460 in 1998 and was designed to succeed Internet Protocol Version 4. In 2005, RFC 4007 was published. RFC 4007 specifies the architectural characteristics and usage of IPv6 addresses with different zones. Some applications (“legacy applications”) were not designed to support the implementations described in RFC 4007. Therefore, the legacy applications may accept IPV6 addresses as input, but may not accept zone identifiers. Embodiments include conveying an IPv6 link-local unicast address with an embedded zone identifier to a legacy application.

### BACKGROUND

Embodiments of the inventive subject matter generally relate to the field of networking, and, more particularly, to conveying IPv6 addresses with embedded zone identifiers to IPv6 legacy applications.

Applications can utilize various communication protocols for relaying digital information across a network. Common examples of communication protocols include Internet Protocol version four and Internet Protocol version six. Communication protocols allow for computer systems to send and receive user data across a network in a reliable manner. As the communication protocols incorporate additional functionalities, using previously developed applications that do not support such functionalities can be problematic.

### SUMMARY

Embodiments include a method for receiving an address buffer from an application in operating system space. The operating system then determines that the address buffer comprises an internet protocol link-local unicast address. The operating system then determines that the internet protocol link-local unicast address comprises a zone identifier value. The operating system generates a destination address structure instance. The operating system then writes the zone identifier value from the internet protocol link-local unicast address into a scope field of the destination address structure instance. The operating system also writes the internet protocol link-local unicast address, with a set of one or more zero values replacing the zone identifier, into an address field of the destination address structure instance.

### BRIEF DESCRIPTION OF THE DRAWINGS

The present embodiments may be better understood, and numerous objects, features, and advantages made apparent to those skilled in the art by referencing the accompanying drawings.

FIG. 1 depicts an example of an operating system extracting an embedded zone identifier from an IPv6 link-local unicast address.

FIG. 2 depicts an example flow diagram of the operations used in an operating system to process an IPv6 link-local unicast address with embedded zone identifier.

FIG. 3 depicts an example of a computing system.

### DESCRIPTION OF EMBODIMENT(S)

The description that follows includes example systems, methods, techniques, instruction sequences and computer program products that embody techniques of the present inventive subject matter. However, it is understood that the described embodiments may be practiced without these specific details. In other instances, well-known instruction instances, protocols, structures and techniques have not been shown in detail in order not to obfuscate the description.

Internet Protocol addresses allow computer systems on a common network to identify one another and communicate by sending and receiving information in packets. A packet includes control information and user data (also referred to herein as “application data”). The control information includes information a network uses to deliver the user data, such as source and destination Internet Protocol addresses (also referred to herein as “IP addresses”). The source IP address identifies the computer system sending a packet, while the destination IP address identifies the computer system receiving a packet.

There are different versions of the Internet Protocol, such as Internet Protocol version 4 (“IPv4”) and Internet Protocol version 6 (“IPv6”). Every IPv6 address has a scope, or a region of a network in which the IPv6 address is valid. One type of IPv6 address is a link-local address. A link-local IPv6 address includes a link-local scope, which indicates that the IPv6 address is to be used in a segment or particular physical link of a local network. Link-local IPv6 addresses can be reused on different networks, which makes link-local addresses ambiguous. In other words, a computer system could be connected to two separate networks and each of these networks could use the same IPv6 link-local address. In order to resolve the ambiguity associated with IPv6 link-local addresses, an additional identifier is used to specify the network on which the destination is located. This additional identifier is a zone identifier (“zone ID”), which identifies an interface or subset of interfaces that are connected to a portion of a network that has a specified scope.

Internet Protocol Version 6 (IPv6) was described in RFC 2460 in 1998 and was designed to succeed Internet Protocol Version 4. In 2005, RFC 4007 was published. RFC 4007 specifies the architectural characteristics and usage of IPv6 addresses with different zones. Some applications (“legacy applications”) were not designed to support the implementations described in RFC 4007. Therefore, the legacy applications may accept IPV6 addresses as input, but do not recognize the notation for a zone identifier.

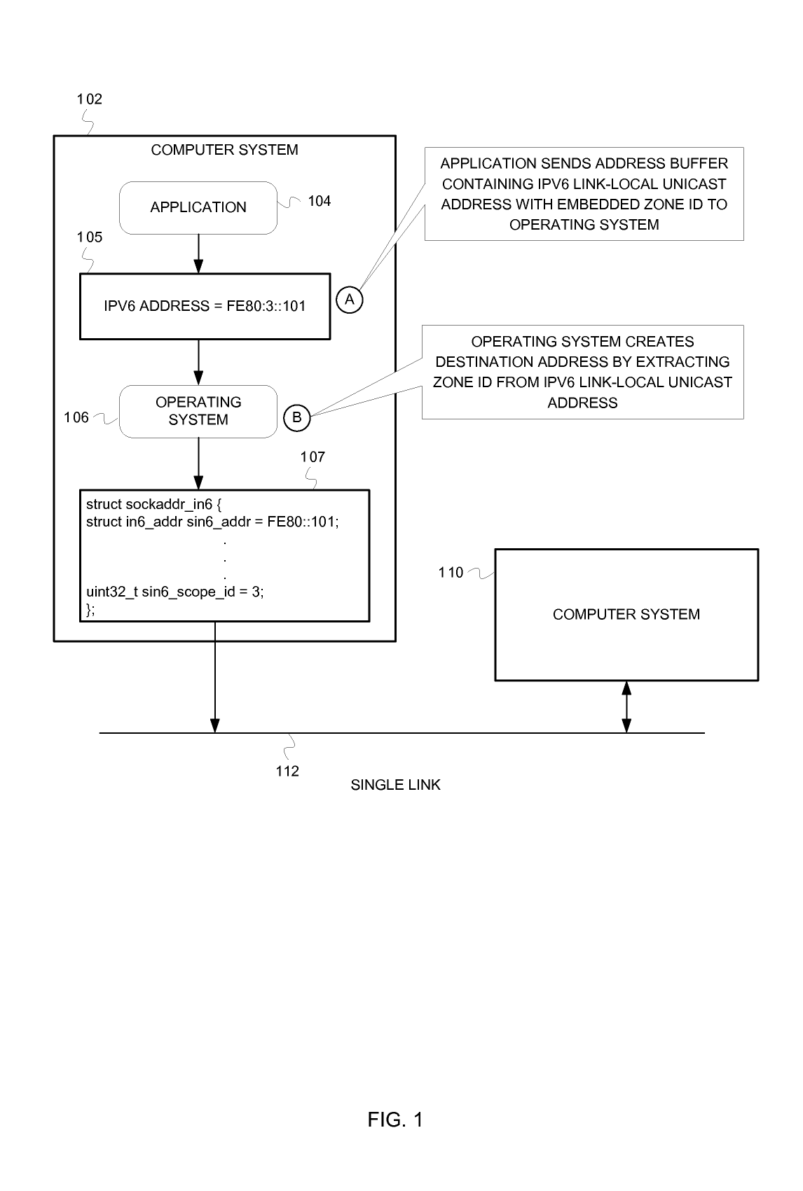

FIG. 1 depicts an example of an operating system extracting an embedded zone identifier from an IPv6 link-local unicast address. Computer system 102 includes an application 104 and an operating system 106. A single link 112 connects computer system 102 to a second computer system 110.

Application 104 receives an IPv6 link-local unicast address with an embedded zone identifier. As discussed above, IPv6 link-local addresses indicate that the IPv6 link-local addresses are to be used in the attached networks or links. A unicast address is a type of IPv6 address that identifies a specific destination interface. The Internet Protocol version 6 uses unicast addresses to send application data to the specific destination interface (e.g., ethernet) identified in the unicast address. Therefore, an IPv6 link-local unicast address refers to a specific destination interface that is within computer system's 102 attached networks.

The IPv6 link-local unicast address with an embedded zone identifier complies with the Internet Protocol version 6 and is 128 bits long. An IPv6 address is represented as eight groups of four hexadecimal digits, each group representing 16 bits. Each group is separated by a colon (“:”). An example of an Ipv6 address is 4102:1fa5:3b4c:0000:0000:7a1f:1730:8591. Any number of consecutive groups of zero values in an Ipv6 address may be replaced with two colons (“::”). For instance, the example Ipv6 address 4102:1fa5:3b4c:0000:0000:7a1f:1730:8591 can be further simplified to 4102:1fa5:3b4c::7a1f:1730:8591 by replacing the consecutive groups of zero values with two colons (“::”).

The zone identifier specifies a particular interface or subset of interfaces that can be used for an outgoing interface. The standard syntax specified in RFC 4007 for identifying the zone associated with an IPv6 link-local unicast address is “<IPv6 address>%<zone ID>”, in which the zone ID is an integer value representing the zone. For instance, an application that complies with RFC 4007 can accept an IPv6 address with a zone identifier of 3 as “FE80::101%3”. Legacy applications can accept an IPv6 link-local unicast address with an embedded zone ID that is entered by a user. For instance, the user may enter “FE80:3::101,” in which the zone identifier is embedded in the IPv6 link-local unicast address. In some instances, the IPv6 link-local unicast address is read from a configuration file by an executing application or script. A script or application can use the IPv6 link-local unicast address with an embedded zone ID notation instead of the IPv6 link-local unicast notation in which the zone ID is appended following a “%” sign. The IPv6 link-local unicast address with embedded zone identifier can be accepted as a proper address by a process (i.e., executing instance of a computer program) within a computer system.

Application 104 then sends the IPv6 link-local unicast address with embedded zone identifier encapsulated in an address buffer into operating system space 106 (Stage A). For example, address buffer 105 contains the address “FE80:3::101.” This represents an IPv6 link-local unicast address with an embedded zone ID value of 3.

Operating system 106 detects an IPv6 address in the address buffer. Operating system 106 analyzes the first ten bits (“prefix”) of the IPv6 address. An IPv6 link-local unicast address has a unique prefix value of “1111111010.” The prefix in an IPv6 link-local unicast address is followed by 54 bits with zero values. If the 54 bits following a link-local unicast prefix contain a non-zero value, then the operating system determines that an IPv6 link-local unicast address with embedded zone identifier has been received. The non-zero value represents the zone ID value. A specific region of the 54 bits following the prefix in the IPv6 link-local unicast address stores the zone ID value. The region used to store the zone ID value (zone ID region) can range in size from eight to thirty-two bits depending on the number of zones on which the computer system resides. In some embodiments, some of the 54 bits following the prefix in an IPv6 link-local unicast address can be used to store data other than the zone ID value. The zone ID value can then be stored in an unused portion of the 54 bits following the prefix. In some embodiments, the IPv6 link-local unicast address is determined to include an embedded zone identifier by code in the kernel that implements the network stack. For example, the code in the kernel may implement the network stack in accordance with the open systems interconnection model. In other embodiments, a kernel extension may determine if an IPv6 link-local unicast address contains an embedded zone identifier.

Operating system 106 then extracts the non-zero value from the zone ID in the IPv6 link-local unicast address and assigns the extracted zone ID to a scope field of a destination address (Stage B). The operating system instantiates a destination address structure. The destination address is a structure with various fields, such as the length of the destination address structure, an address family, a port number, an IPv6 address and a scope ID. The address family refers to the Internet Protocol version being used, such as IPv6. The port number contains a 16 bit UDP or TCP port number. The zone ID is stored in the scope ID field of the destination address structure. Operating system 106 then fills the zone ID region in the IPv6 link-local unicast address with zero values. Operating system 106 copies the IPv6 link-local unicast address without the embedded zone ID to the sin 6_addr field of an instance of the destination address.

Operating system 106 then uses the instance of destination address 107, which contains the zone ID and the IPv6 address without the zone ID, to send application data to another computer system 110 via connected link 112. For example, the IPv6 link-local unicast address with an embedded zone ID “FE80:3::101” is stored as “FE80::101” in the sin 6_addr field in the destination address instance (“sockaddr_in6”) 107. The scope ID field (“sin 6_scope_id”) of the instance of destination address 107 contains the zone ID value of 3. The destination address instance now contains a valid IPv6 address and the proper zone for the IPv6 address. Therefore, the destination address instance can be used to send application data to other computer systems located within the same network, such as computer system 110.

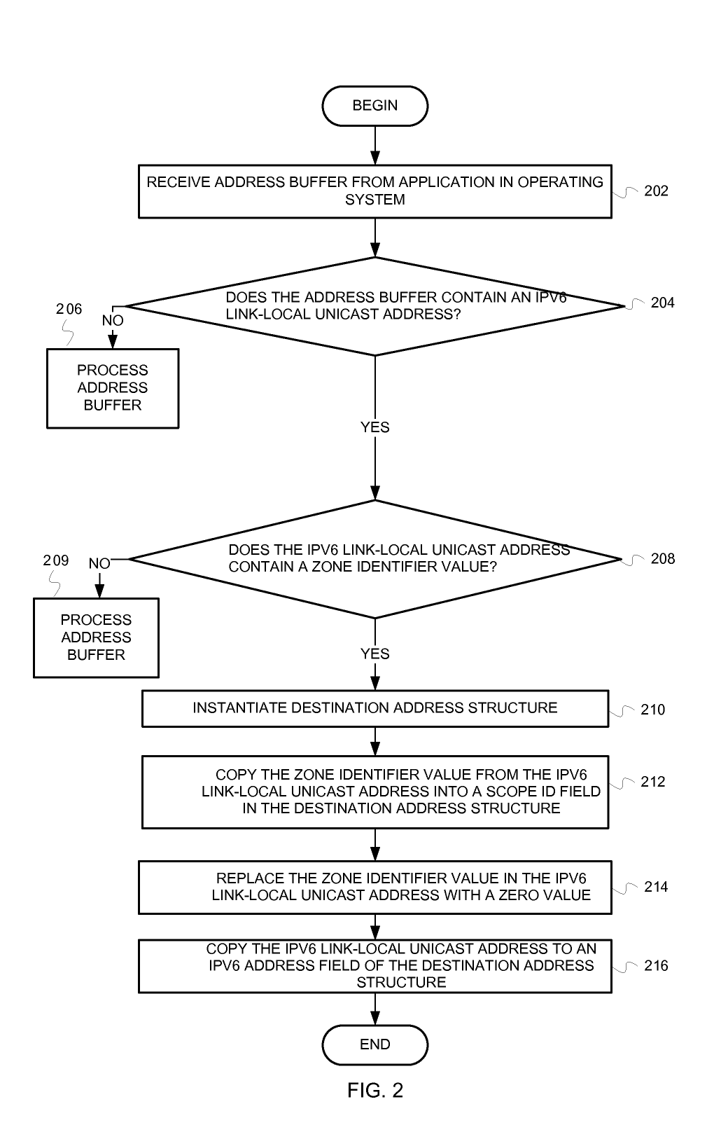

FIG. 2 depicts an example flow diagram of the operations used in an operating system to process an IPv6 link-local unicast address with embedded zone identifier.

The operating system receives an address buffer from an application (block 202). The address buffer contains an IPv6 address detected in the application.

It is then determined if the address buffer contains an IPv6 link-local unicast address (block 204). An IPv6 link-local unicast address can be determined by the first 10 bits of the address. IPv6 link-local unicast addresses have a unique prefix of “1111111010.” Therefore, if the prefix of the IPv6 address in the address buffer has a value of “1111111010,” the address buffer contains an IPv6 link-local unicast address.

If the address buffer does not contain an IPv6 link-local unicast address, then the IP address in the address buffer is processed (block 206). For instance, the code in the kernel that implements the network stack determines the destination for the IP address and causes the application data to be transmitted to the destination.

If the address buffer does contain an IPv6 link-local unicast address, then it must be determined if the IPv6 link-local unicast address contains a zone identifier (block 208). The determination can be made by analyzing the 54 bits of zeros following the prefix of the IPv6 link-local unicast address. If these 54 bits contain a non-zero value, then a zone ID has been embedded in the IPv6 link-local unicast address.

If the IPv6 link-local unicast address does not contain a zone ID, then the IPv6 link-local unicast address in the address buffer is processed (block 209).

If the IPv6 link-local unicast address contains a zone ID, then a destination address is instantiated (block 210). The destination address is a structure that includes various fields, such as IP address and zone ID.

The zone identifier is then copied from the IPv6 link-local unicast address into the scope ID field of an instance of the destination address (block 212). The zone identifier is copied by removing the zone ID value from the IPv6 link-local unicast address and placing the zone ID value in the scope ID field of the instance of the destination address.

The zone ID value in the IPv6 link-local unicast address is then replaced with a zero value (block 214). The IPv6 link-local unicast address now represents a valid and routable IPv6 link-local unicast address that can be used to send application data via a connected network.

The link-local unicast address is then copied to the IP address field of the instance of the destination address (block 216). The instance of the destination address now contains a valid and routable link-local unicast IPv6 address and a zone ID.

It should be understood that FIG. 2 is an example meant to aid in understanding embodiments and should not be used to limit embodiments or limit scope of the claims. Embodiments may perform additional operations, fewer operations, operations in a different order, operations in parallel, and some operations differently. In some embodiments, the IPv6 link-local unicast address is copied to an instance of the destination address (block 216) before the zone ID is copied from the IPv6 link-local unicast address to the instance of the destination address (block 212). The zone ID value within the IPv6 link-local unicast address is then replaced with a zero value while the IPv6 link-local unicast address is in the instance of a destination address.

Although the above examples describe using a number based zone identifier, embodiments are not so limited. Embodiments can include an operating system identifying embedded zone identifiers with non-numerical characters. If an operating system detects a zone identifier with non-numerical characters, the operating system can map the non-numerical characters to a number. For example, a non-numerical zone identifier such as “eth0” can be mapped to a corresponding numerical zone identifier such as “0”.

As will be appreciated by one skilled in the art, aspects of the present inventive subject matter may be embodied as a system, method or computer program product. Accordingly, aspects of the present inventive subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present inventive subject matter may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present inventive subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present inventive subject matter are described with reference to flowchart illustrations and/or block diagrams of methods, apparatus (systems) and computer program products according to embodiments of the inventive subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

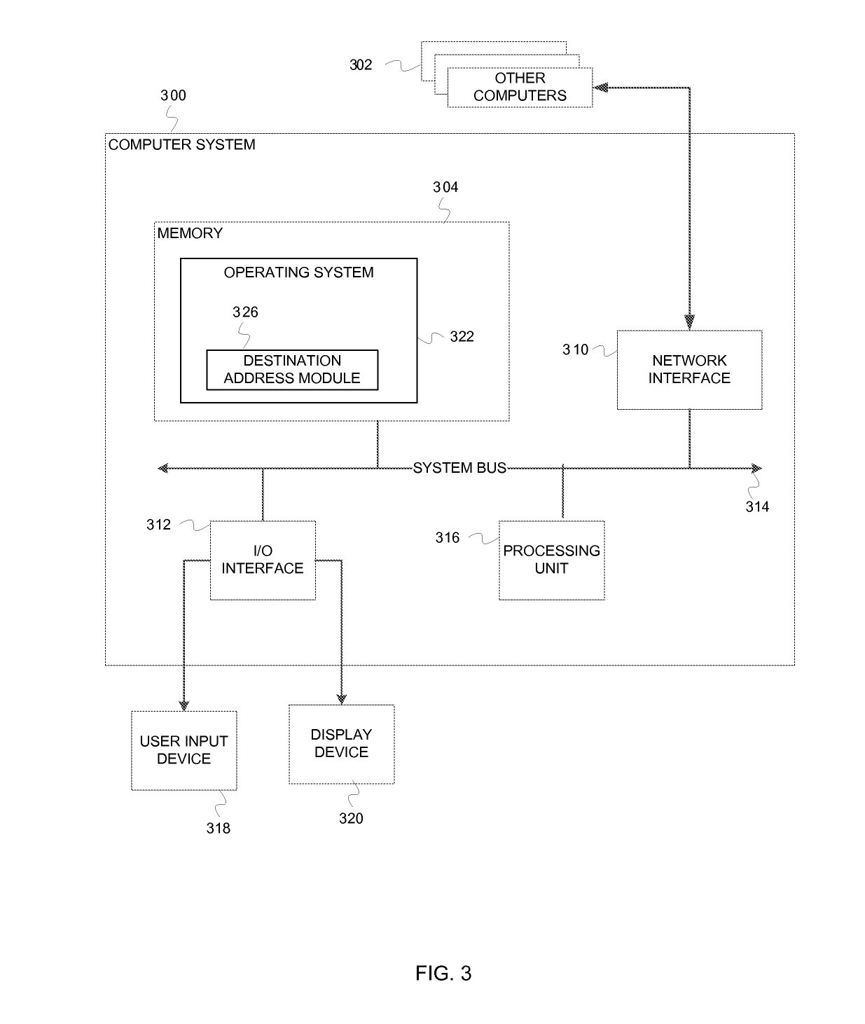

FIG. 3 depicts an example computer system. A computer system 300 includes a processing unit 316 (possibly including multiple processors, multiple cores, multiple nodes, and/or implementing multi-threading, etc.). Computer system 300 includes memory 304. Memory 304 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 314 (e.g., PCI, ISA, PCI-Express, HyperTransport®, InfiniBand®, NuBus, etc.), a network interface 310 (e.g., an ATM interface, an Ethernet interface, a Frame Relay interface, SONET interface, wireless interface, etc.), and an I/O (input/output) interface 312. Network interface 310 allows computer system 300 to communicate (e.g., send and receive data) with other computers 302. Input/output interface adapters in computers can implement user-oriented input/output through, for example, software drivers and computer hardware. The I/O interface may utilize various display devices 320, such as computer display screens, and various user input devices 318, such as keyboards and mice.

Memory 304 includes an operating system 322. Operating system 322 includes a destination address module 326, which embodies functionality to implement embodiments described above. Destination address module 326 may include one or more functionalities that facilitate conveying zone identifiers embedded in IPv6 link-local unicast addresses through applications that do not support a separate notation for the zone identifier, such as a notation in accordance with RFC 4007. Some or all of these functionalities may be partially (or entirely) implemented with code embodied in the memory 304 and/or processing unit 316, co-processor, other cards, etc. Any one of these functionalities may also be partially (or entirely) implemented in hardware and/or on processing unit 316. For example, the functionality may be implemented with an application specific integrated circuit, in logic implemented in processing unit 316, in a co-processor on a peripheral device or card, etc. Further, realizations may include fewer or additional components not illustrated in FIG. 3 (e.g., video cards, audio cards, additional network interfaces, peripheral devices, etc.). Processor unit 316, I/O interface 312, and network interface 310 are coupled to bus 314. Although illustrated as being coupled to bus 314, memory 304 may be coupled to processor unit 316.

While the embodiments are described with reference to various implementations and exploitations, it will be understood that these embodiments are illustrative and that the scope of the inventive subject matter is not limited to them. In general, techniques for conveying zone identifiers embedded in IPv6 link-local unicast addresses through applications that do not support a separate notation for the zone identifier, such as a notation in accordance with RFC 4007, as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method comprising:
determining that an address buffer comprises an internet protocol link-local unicast address responsive to receiving the address buffer into operating system space from an application;
determining that the internet protocol link-local unicast address comprises a zone identifier value;
generating a destination address structure instance;
writing the zone identifier value from the internet protocol link-local unicast address into a scope field of the destination address structure instance; and
writing the internet protocol link-local unicast address, with a set of one or more zero values replacing the zone identifier, into an address field of the destination address structure instance.

2. The method of claim 1, wherein said writing the internet protocol link-local unicast address comprises:
replacing the zone identifier value in the internet protocol link-local unicast address with the set of one or more zero values; and
copying the internet protocol link-local unicast address to an IPv6 address field of the destination address structure instance.

3. The method of claim 1, wherein the internet protocol link-local unicast address comports with the Internet Protocol, Version 6 (IPv6) Specification.

4. The method of claim 1, wherein the internet protocol link-local unicast address represents a single link that connects a plurality of computer systems.

5. The method of claim 4, wherein the internet protocol link-local unicast address represents a destination interface.

6. The method of claim 1, wherein the zone identifier value indicates an outgoing interface.

7. The method of claim 1, wherein the destination address structure instance further comprises a field indicating the length of the destination address structure, a field indicating an address family, and a field indicating a port number.

8. The method of claim 1, wherein the destination address structure instance comports with the Basic Socket Interface Extensions for IPv6.

9. The method of claim 1, wherein said determining that the internet protocol link-local unicast address comprises the zone identifier value, wherein a kernel process or a kernel extension process performs said determining.

10. A computer program product for conveying a zone identifier embedded in an internet protocol link-local unicast address, the computer program product comprising:
a computer readable storage medium having computer readable program code embodied therewith, the computer readable program code configured to,
determine that an address buffer comprises an internet protocol link-local unicast address responsive to receiving the address buffer into operating system space from an application;
determine that the internet protocol link-local unicast address comprises a zone identifier value;
generate a destination address structure instance;
write the zone identifier value from the internet protocol link-local unicast address into a scope field of the destination address structure instance; and
write the internet protocol link-local unicast address, with a set of one or more zero values replacing the zone identifier, into an address field of the destination address structure instance.

11. The computer program product of claim 10, wherein the computer readable program code being configured to write the internet protocol link-local unicast address comprises the computer readable program code being configured to,
replace the zone identifier value in the internet protocol link-local unicast address with the set of one or more zero values; and
copy the internet protocol link-local unicast address to an IPv6 address field of the destination address structure instance.

12. The computer program product of claim 10, wherein the internet protocol link-local unicast address comports with the Internet Protocol, Version 6 (IPv6) Specification.

13. The computer program product of claim 10, wherein the internet protocol link-local unicast address represents a single link that connects a plurality of computer systems.

14. The computer program product of claim 13, wherein the internet protocol link-local unicast address represents a destination interface.

15. The computer program product of claim 10, wherein the zone identifier value indicates an outgoing interface.

16. An apparatus comprising:
a processor;
a memory coupled with the processor; and
a reliability value module configured to:
determine that an address buffer comprises an internet protocol link-local unicast address responsive to receiving the address buffer into operating system space from an application;
determine that the internet protocol link-local unicast address comprises a zone identifier value;
generate a destination address structure instance;
write the zone identifier value from the internet protocol link-local unicast address into a scope field of the destination address structure instance; and
write the internet protocol link-local unicast address, with a set of one or more zero values replacing the zone identifier, into an address field of the destination address structure instance.

17. The apparatus of claim 16, wherein the reliability value module being configured to write the internet protocol link-local unicast address comprises the reliability value module being configured to,
replace the zone identifier value in the internet protocol link-local unicast address with the set of one or more zero values; and
copy the internet protocol link-local unicast address to an IPv6 address field of the destination address structure instance.

18. The apparatus of claim 16, wherein the internet protocol link-local unicast address comports with the Internet Protocol, Version 6 (IPv6) Specification.

19. The apparatus of claim 16, wherein the internet protocol link-local unicast address represents a single link that connects a plurality of computer systems.

20. The apparatus of claim 16, wherein the zone identifier value indicates an outgoing interface.
